(19) United States
(12) Patent Application Publication
(10) Pub. No.: US 2007/0224456 A1
(43) Pub. Date: Sep. 27, 2007

(54) Magnetic recording medium and method for production thereof

(75) Inventors: Naoto Murao, Odawara-shi (JP); Youhei Aritoshi, Odawara-shi (JP)

Correspondence Address: SUGHRUE-265550, 2100 PENNSYLVANIA AVE. NW, WASHINGTON, DC, 20037-3213, US

(73) Assignee: FUJIFILM Corporation, Minato-ku (JP)

(21) Appl. No.: 11/727,534

(22) Filed: Mar. 27, 2007

(30) Foreign Application Priority Data
Mar. 27, 2006 (JP) 2006-086360

(51) Int. Cl. G11B 5/716; B05D 5/12

(52) U.S. Cl. 428/840.2; 427/131

(57) ABSTRACT

A magnetic recording medium including: a nonmagnetic support; a smoothing layer containing a polymer; a nonmagnetic layer formed by coating a first solution containing nonmagnetic powder and a binder on the smoothing layer and drying the coated first solution; and a magnetic layer formed by coating a second solution containing ferromagnetic powder, inorganic powder and a binder on the nonmagnetic layer and drying the coated second solution, in this order.

### FIELD OF THE INVENTION

The present invention relates to a magnetic recording medium and a method for production thereof, more particularly to a magnetic recording medium which can be preferably used as a backup tape for large capacity data of 1 TB or more per reel, is excellent in electromagnetic conversion characteristics and depresses abrasion of a head, and a method for production thereof.

### BACKGROUND OF THE INVENTION

In recent years, the needs of high density recording for magnetic recording media have increased and magnetic recording media having high electromagnetic conversion characteristics have been required. The reliability at which the data are repeatedly used and stored is also requested at the same time. Accordingly, the good running durability has been demanded in addition to the excellent electromagnetic conversion characteristics.

In order to achieve the high electromagnetic conversion characteristics, it is important to shorten the distance between a reproducing head and the recording medium as much as possible, to make the magnetic layer as thin as possible and to increase a filling rate in the magnetic layer as much as possible.

Thus, (1) a technique of increasing the smoothness and filling rate by improving dispersibility of a coating solution for forming the magnetic layer or by strengthening the calendering conditions after coating, (2) a technique of reducing thickness of the magnetic layer to a level of 0.2 to 0.3 μm by coating simultaneously a nonmagnetic layer and the magnetic layer in the wet state, and (3) a technique of improving the running durability by preventing the increase in the friction coefficient due to smoothing based on the introduction of lubricant excellent in slidability, for example, an aliphatic acid ester or hornlike α-alumina which is fine particle and excellent in abradability have hitherto been proposed.

However, in order to further increase the density, a technique of reducing the thickness of magnetic layer to not more than 0.1 μm and a technique of smoothing the surface of magnetic layer are necessary. In particular, in the latter case, the formulation of magnetic layer and production technique therefor which achieve centerline average surface roughness of not more than 3 nm and also satisfy the durability are requested. The techniques of providing a smoothing layer between the nonmagnetic support and the magnetic layer for the purpose of smoothening are described in JP-A-2003-132522, JP-A-2003-132530 and JP-A-2005-203024 (corresponding to US 2005/0238928 A1).

### SUMMARY OF THE INVENTION

With respect to the technique of reducing the thickness of magnetic layer to not more than 0.1 μm, a so-called simultaneous multilayer coating method wherein the nonmagnetic layer and the magnetic layer are simultaneously coated in the wet state to reduce thickness of the magnetic layer is difficult to reduce the thickness of the magnetic layer to not more than 0.1 μm because mixture of a coating solution for forming the nonmagnetic layer and a coating solution for forming the magnetic layer occurs. From this point of view, it is desirable to employ a so-called successive coating method wherein after the formation of the nonmagnetic layer, the nonmagnetic layer is coated. However, since an abrasive contained in the coating solution for forming the magnetic layer can not penetrate into the nonmagnetic layer according to the successive coating method, it is impossible to form a smooth surface in comparison with the simultaneous multilayer coating method even when the calendering conditions are strengthened. Further, since the protrusion amount of the abrasive through the surface of the magnetic layer increases, abrasion of the head severely proceeds and practical performances can not be obtained in some cases. Although it is possible to use a fine particle abrasive having a size smaller than the thickness of the magnetic layer, in the case wherein the thickness of the magnetic layer is reduced to not more than 0.1 μm, since abrasion property of the abrasive extremely decreases, the cleaning performance deteriorates to cause harmful effects, for example, staining of the head at the running.

An object of the present invention is to provide a magnetic recording medium, which achieves the high smoothness of magnetic layer and reduction in the thickness of magnetic layer, which sufficiently exerts performances of inorganic powder, for example, abrasive, which has the excellent electromagnetic conversion characteristics and running durability, which has a low error rate and high accuracy of record reproduction and which can prevent the abrasion of head, and a method for production thereof.

The present invention includes the following items.
(1) A magnetic recording medium comprising forming on a nonmagnetic support a smoothing layer mainly containing a polymer, coating on the smoothing layer a coating solution for forming a nonmagnetic layer containing nonmagnetic powder and a binder, followed by drying to form a nonmagnetic layer, and coating on the nonmagnetic layer a coating solution for forming a magnetic layer containing ferromagnetic powder, inorganic powder and a binder, followed by drying to form a magnetic layer.
(2) The magnetic recording medium as described in (1) above, wherein an average particle size (d) of at least one kind of the inorganic powder contained in the magnetic layer and thickness (t) of the magnetic layer satisfy the relation d≧t.
(3) The magnetic recording medium as described in (1) or (2) above, wherein thickness of the magnetic layer is not more than 0.15 μm.
(4) A method for production of a magnetic recording medium comprising coating on a nonmagnetic support a coating solution for forming a smoothing layer, followed by drying to form a smoothing layer mainly containing a polymer, coating on the smoothing layer a coating solution for forming a nonmagnetic layer containing nonmagnetic powder and a binder, followed by drying to form a nonmagnetic layer, and coating on the nonmagnetic layer a coating solution for forming a magnetic layer containing ferromagnetic powder, inorganic powder and a binder, followed by drying to form a magnetic layer.

According to the present invention, a magnetic recording medium, which achieves the high smoothness of magnetic layer and reduction in the thickness of magnetic layer, which sufficiently exerts performances of inorganic powder, for example, abrasive, which has the excellent electromagnetic conversion characteristics and running durability, which has a low error rate and high accuracy of record reproduction and which can prevent the abrasion of head, and a method for production thereof can be provided.

### DETAILED DESCRIPTION OF THE INVENTION

Now, the present invention is described in more detail below.

### 1. Nonmagnetic Support

The nonmagnetic support which can be used in the invention includes known supports, for example, a biaxially stretched film of polyethylene terephthalate, polyethylene naphthalate, polyamide, polyamideimide or aromatic polyamide. Among them, a nonmagnetic support made of polyethylene terephthalate, polyethylene naphthalate or polyamide is preferred.

The support may be previously subjected to a surface treatment, for example, a corona discharge treatment, a plasma treatment, a treatment for easy adhesion or a heat treatment. With respect to the surface roughness, the nonmagnetic support for use in the invention preferably has centerline average surface roughness Ra of 3 to 10 nm measured with a cut-off value of 0.25 mm.

### 2. Smoothing Layer

As a means of forming the smoothing layer, a means (1) or (2) described below is preferably employed. However, the invention should not be construed to preclude the adoption of other means than those described above. (1) A means of forming the smoothing layer by coating on the surface of a support a coating solution containing a compound having a radiation-cur-able functional group in its molecule and irradiating the coating layer with radiation to cure the coating layer. (2) A means of forming the smoothing layer by coating on the surface of a support by coating a polymer solution and drying.

First, the means (1) will be described below.

The terminology “compound having a radiation-curable functional group in its molecule” (hereinafter, also referred to as a radiation-curable compound) as used herein means a compound having a property capable of becoming a high molecular weight compound and being cured by polymerization or crosslinking when energy upon radiation, for example, electron beam or ultraviolet ray, is applied. The radiation-curable compound does not initiate the reaction as long as such energy is not applied. Therefore, a coating solution containing the radiation-curable compound is stable in its viscosity as long as it is not irradiated with the radiation, and high coating layer smoothness can be obtained.

Further, since the reaction proceeds in a moment upon high energy of the radiation, high coating layer strength can be obtained. The molecular weight of the radiation-curable compound is preferably in a range of 200 to 2,000. When the molecular weight of the resin is in the above-described range, since the molecular weight is comparatively low, the coating layer can easily flow and exhibits high formability at the calendering step so that a smooth coating layer can be obtained.

As the difunctional or higher functional radiation-curable compounds, acrylic esters, acrylamides, methacrylic esters, methacrylic acid amides, allyl compounds, vinyl ethers and vinyl esters are exemplified.

Specific examples of the difunctional radiation-curable compound include those obtained by adding acrylic acid or methacrylic acid to an aliphatic diol as typified, for example, by ethylene glycol diacrylate, propylene glycol diacrylate, butanediol diacrylate, hexanediol diacrylate, diethylene glycol diacrylate, triethylene glycol diacrylate, tetraethylene glycol diacrylate, neopentyl glycol diacrylate, tripropylene glycol diacrylate, ethylene glycol dimethacrylate, propylene glycol dimethacrylate, butanediol dimethacrylate, hexanediol dimethacrylate, diethylene glycol dimethacrylate, triethylene glycol dimethacrylate, tetraethylene glycol dimethacrylate, neopentyl glycol dimethacrylate and tripropylene glycol dimethacrylate.

Further, a polyether acrylate or polyether methacrylate obtained by adding acrylic acid or methacrylic acid to a polyether polyol, for example, polyethylene glycol, polypropylene glycol or polytetramethylene glycol, or a polyester acrylate or polyester methacrylate obtained by adding acrylic acid or methacrylic acid to a known polyester polyol obtained from a dibasic acid and a glycol can also be used.

A polyurethane acrylate or polyurethane methacrylate obtained by adding acrylic acid or methacrylic acid to a known polyurethane obtained by reacting a polyol or diol with a polyisocyanate can also be used. A compound obtained by adding acrylic acid or methacrylic acid to bisphenol A, bisphenol F, hydrogenated bisphenol A, hydrogenated bisphenol F, or an alkylene oxide adduct thereof, or a compound having a cyclic structure, for example, isocyanuric acid alkylene oxide-modified diacrylate, isocyanuric acid alkylene oxide-modified dimethacrylate, tricyclodecanedimethanol diacrylate and tricyclodecanedimethanol dimethacrylate can also be used.

Specific examples of the trifunctional radiation-curable compound include trimethylolpropane triacrylate, trimethylolethane triacrylate, alkylene oxide-modified triacrylate of trimethylolpropane, pentaerythritol triacrylate, dipentaerythritol triacrylate, isocyanuric acid alkylene oxide-modified triacrylate, propionic acid dipentaerythritol triacrylate, hydroxypivaloyl aldehyde-modified dimethylolpropane triacrylate, trimethylolpropane trimethacrylate, alkylene oxide-modified trimethacrylate of trimethylolpropane, pentaerythritol trimethacrylate, dipentaerythritol trimethacrylate, isocyanuric acid alkylene oxide-modified trimethacrylate, propionic acid dipentaerythritol trimethacrylate and hydroxypivaloyl aldehyde-modified dimethylolpropane trimethacrylate.

Specific examples of the tetrafunctional or higher functional radiation-curable compound include pentaerythritol tetraacrylate, ditrimethylolpropane tetraacrylate, dipentaerythritol pentaacrylate, propionic acid dipentaerythritol tetraacrylate, dipentaerythritol hexaacrylate and alkylene oxide-modified hexaacrylate of phosphazene.

Of these specific compounds, a difunctional acrylate compound having a molecular weight of 200 to 2,000 is preferable, and the compound obtained by adding acrylic acid or methacrylic acid to bisphenol A, bisphenol F, hydrogenated bisphenol A, hydrogenated bisphenol F, or an alkylene oxide adduct thereof is more preferable.

The radiation-curable compound for use in the invention may be used in combination with a polymer type binder. As the binder, a polymer used in the means (2) described hereinafter, a conventionally known thermoplastic resin, thermosetting resin or reactive resin or a mixture thereof is used. When ultraviolet ray is used as the radiation, it is preferred to use a polymerization initiator in combination. As the polymerization initiator, a photo-radical polymerization initiator, a photo-cation polymerization initiator or a photoamine generator can be used.

Examples of the photo-radical polymerization initiator include an α-diketone, for example, benzyl or diacetyl, an acyloin, for example, benzoin, an acyloin ether, for example, benzoin methyl ether, benzoin ethyl ether or benzoin isopropyl ether, a thioxanthone, for example, thioxanthone, 2,4-diethylthioxanthone or thioxanthone-4-sulfonic acid, benzophenone, for example, benzophenone, 4,4′-bis(dimethylamino)benzophenone, or 4,4′-bis(diethylamino) benzophenone, a Michler's ketone, an acetophenone, for example, acetophenone, 2-(4-toluenesulfonyloxy)-2-phenylacetophenone, p-dimethylaminoacetophenone, α,α′-dimethoxyacetoxybenzophenone, 2,2′-dimethoxy-2-phenylacetophenone, p-methoxyacetophenone, 2-methyl-[4-(methylthio)phenyl]-2-morpholino-1-propanone or 2-benzyl-2-dimethylamino-1-(4-morpholinophenyl)butan-1-one, a quinone, for example, anthraquinone or 1,4-naphthoquinone, a halogen compound, for example, phenacylchloride, trihalomethylphenylsulfone, or tris(trihalomethyl)-s-triazine, an acylphosphine oxide and a peroxide, for example, di-t-butyl peroxide.

As the photo-radical polymerization initiator, a commercially available product, for example, IRGACURE-184, IRGACURE-261, IRGACURE-369, IRGACURE-500, IRGACURE-651 and IRGACURE-907 (produced by Ciba Geigy Ltd.), Darocur-1173, Darocur-1116, Darocur-2959, Darocur-1664 and Darocur-4043 (produced by Merck Japan Ltd.), KAYACURE-DETX, KAYACURE-MBP, KAYACURE-DMBI, KAYACURE-EPA and KAYACURE-OA (produced by Nippon Kayaku Co., Ltd.), VICURE-10 and VICURE-55 (produced by STAUFFER Co., Ltd.), TRIGONAL P1 (produced by AKZO Co., Ltd.), SANDORAY 1000 (produced by SANDOZ Co., Ltd.), DEAP (produced by APJOHN Co., Ltd.), QUANTACURE-PDO, QUANTACURE-ITX and QUANTACURE-EPD (produced by WARD BLEKINSOP Co., Ltd.) can also be used.

As the photo-cation polymerization initiator, a diazonium salt, a triphenylsulfonium salt, a metallocene compound, a diaryl iodonium salt, a nitrobenzyl sulfonate, α-sulfonyloxy ketone, a diphenyldisulfone or an imidyl sulfonate is exemplified. As the photo-cation polymerization initiator, a commercially available product, for example, Adeka Ultraset PP-33, OPTMER SP-150 and OPTMER SP-170 (diazoniumsalts) (produced by ADEKA Corp.), OPTOMER SP-150 and OPTOMER SP-170 (sulfonium salts) (produced by ADEKA Corp.) and IRGACURE 261 (metallocene compound) (produced by Ciba Geigy Ltd.) can also be used.

As the photoamine generator, a nitrobenzcarbamate or an iminosulfonate is exemplified. The photopolymerization initiator used is appropriately selected according to exposure conditions (for example, whether oxygen atmosphere or oxygen-free atmosphere) or the like. The photopolymerization initiators can be used in combination of two or more thereof.

The composition containing the radiation-curable compound and, further, the other binder and the photopolymerization initiator is made a coating solution in a solvent which dissolves the composition. The solvent is appropriately selected from the solvents described hereinafter. After the coating solution is coated on a support and dried, the coating layer is ordinarily irradiated with the radiation. The drying may be either natural drying or drying with heating.

When electron beam is used as the radiation, the dose thereof is preferably from 1 to 20 Mrad in total, and more preferably from 3 to 10 Mrad in total. When ultraviolet ray is used as the radiation, the dose thereof is preferably from 10 to 100 mJ/cm². With respect to the irradiation apparatus of ultraviolet ray (UV) or electron beam (EB) and irradiation conditions, known apparatus and conditions, for example, those described in UV·EB Koka Gijutsu (Curing Techniques with UV and EB), Sogo Gijutsu Center Co., Ltd. and Tei-Energy Denshisen Shosha no Oyo Gijutsu (Applied Technology of Low Energy Electron Beam Irradiation), CMC Publishing Co., Ltd. (2000) can be used.

Now, the means (2) of forming the smoothing layer is described below.

The polymer solution used preferably has viscosity of 50 cp (0.05 Pa·s) or lower, more preferably 30 cp (0.03 Pa·s) or lower. The surface tension of the coating solution is preferably 22 mN/m or higher, and more preferably 24 mN/m or lower. The polymer preferably has a number average molecular weight of 10,000 to 100,000. When a coating layer is provided on the smoothing layer to form a magnetic recording medium, a polymer insoluble or hardly soluble in the solvent for the coating layer is preferably used, and a water-soluble polymer is particularly preferred. The glass transition temperature (Tg) of the polymer is preferably from 0 to 120° C., and more preferably from 10 to 80° C. When the glass transition temperature of the polymer is less than 0° C., blocking may occur at the end face in some cases, and when it exceeds 120° C., the internal stress of the smoothing layer is not relaxed and as a result, the adhesive strength may not be secured in some cases.

The polymer used is not particularly limited, and those which satisfy the above-described conditions are preferred, including, for example, a polyamide, a polyamideimide, a polyester, a polyurethane and an acrylic resin. As the polyamide, a polycondensation compound of a diamine and a dicarboxylic acid, a ring opening polymerization compound of a lactam or a copolymer of a salt of a diamine and a dicarboxylic acid (1/1 by molar ratio) and a lactam, for example, caprolactam is exemplified.

As the diamine, hydrazine, methylenediamine, ethylenediamine, trimethylenediamine, tetramethylenediamine, pentamethylenediamine, hexamethylenediamine, heptamethylenediamine, octamethylenediamine, nonamethylenediamine, decamethylenediamine, diaminocyclohexane, di(aminomethyl)cyclohexane, bis(4-aminocyclohexyl)methane, bis(4-amino-3,5-methylcyclohexyl)methane, o-phenylenediamine, m-phenylenediamine, p-phenylenediamine, 4,4′-diaminobiphenyl, tolylenediamine, xylenediamine, naphthylenediamine, bis(aminomethyl)piperazine, bis(aminoethyl)piperazine, bis(aminopropyl)piperazine, 1-(2-aminomethyl)piperazine, 1-(2-aminoethyl)piperazine or 1-(2-aminopropyl)piperazine can be used.

As the dicarboxylic acid, oxalic acid, malonic acid, succinic acid, glutaric acid, adipic acid, pimelic acid, azelaic acid, sebacic acid, cyclohexanedicarboxylic acid, orthophthalic acid, isophthalic acid, terephthalic acid or naphthalenedicarboxylic acid, or an acid anhydride thereof can be used. As the lactam, α-pyrrolidone, α-piperidone, γ-butyrolactam, δ-valerolactam, ε-caprolactam, ω-capryllactam and ω-laurolactam can be used.

As the polyamide, an amino acid polymer is also exemplified. The amino acid polymer may be a synthetic polymer or a natural polymer, for example, protein, e.g., collagen. Further, the polyamide can be used by appropriately selecting from those described in Plastic Zairyo Koza (16) (Course of Plastic Materials (16)), Polyamide Jushi (Polyamide Resins), compiled by Osamu Fukumoto, The Nikkan Kogyo Shinbun, Ltd., Gosei Kobunshi V (Synthetic Polymers V), compiled by Murahashi, Imoto and Tani, Asakura Publishing Co., Ltd., U.S. Pat. Nos. 2,130,497, 2,130,523, 2,149,273, 2,158,064, 2,223,403, 2,249,627, 2,534,347, 2,540,352, 2,715,620, 2,756,221, 2,939,862, 2,994,693, 3,012,994, 3,133,956, 3,188,228, 3,193,475, 3,193,483, 3,197,443, 3,226,362, 3,242,134, 3,247,167, 3,299,009, 3,328,352 and 3,354,123, and polyamides having a tertiary amino group described in JP-A-11-283241.

The polyamideimide can be obtained by a method of reacting a low molecular weight polyamide having an amino group at the terminal with an acid dianhydride or an ester thereof, a method of reacting a low molecular weight polyamide acid having an amino group at the terminal with a dibasic acid chloride, or a method of reacting a trimellitic acid derivative with a diamine.

As the polyamide component, those formed from the diamine and the dicarboxylic acid or amino acid as described in the above polyamide are exemplified. As the diamine for use in the reaction with the trimellitic acid derivative, the above-described diamine is exemplified. As the acid dianhydride and the ester thereof, pyromellitic acid-1,4-dimethyl ester, pyromellitic acid tetramethyl ester, pyromellitic acid ethyl ester, 2,3,6,7-naphthalenetetracarboxylic acid dianhydride, 3,3′,4,4′-biphenyltetracarboxylic acid dianhydride, 1,2,5,6-naphthalenetetracarboxylic acid dianhydride, 2,2′,3,3′-biphenyltetracarboxylic acid dianhydride, and 2,2′,6,6′-biphenyltetracarboxylic acid dianhydride are exemplified.

The low molecular weight polyamide having an amino group at the terminal can be formed by a reaction of the above-described diamine with an acid dianhydride and a ester thereof. As the dibasic acid chloride, a chloride of the above-described dicarboxylic acid can be exemplified. The polyamideimide used can be appropriately selected from those described, for example, in Polyamide Jushi Handbook (Polyamide Resin Handbook), The Nikkan Kogyo Shinbun, Ltd.

As the polyester, a polyester synthesized from a dicarboxylic acid and a glycol is exemplified. As the dicarboxylic acid, an aromatic, aliphatic or alicyclic dicarboxylic acid, specifically the same as those described above is exemplified. The aromatic dicarboxylic acid is preferably used.

As the glycol component, an aliphatic, alicyclic or aromatic glycol, for example, ethylene glycol, diethylene glycol, triethylene glycol, tetraethylene glycol, propylene glycol, butanediol, neopentyl glycol, hexanediol, cyclohexanediol, cyclohexanedimethanol or bisphenol A is exemplified.

As the polyurethane, a polyurethane produced from a polyol, a diisocyanate and a chain extender according to a known method is exemplified. As the polyol, a polyester polyol, a polyether polyol or a polycarbonate polyol is used. As the polyester component of the polyester polyol, the diol of the above-described polyester is exemplified. As the diisocyanate, a diisocyanate described in the binder for use in the magnetic layer hereinafter is exemplified. As the chain extender, a polyhydric alcohol or a polyamine (for example, the above-described diamine) is used.

As the polymer which is used for the formation of the smoothing layer, it is preferred to use a polymer to which at least one polar group selected from —COOM, —SO₃M, —OSO₃M, —P═O(OM)₂, —O—P═O(OM)₂ (wherein M represents a hydrogen atom, an alkali metal or an ammonium), —OH, —NR₂, —N⁺R₃ (wherein R represents a hydrocarbon group), an epoxy group, —SH and —CN is introduced by copolymerization or addition reaction, if desired. The amount of the polar group is preferably determined in a range of 0.1 to 3 meq/g.

In the means (1) or (2), as a solvent for the coating solution for the smoothing layer, a ketone, for example, acetone, methyl ethyl ketone, methyl isobutyl ketone, diisobutyl ketone, cyclohexanone, isophorone or tetrahydrofuran, an alcohol, for example, methanol, ethanol, propanol, butanol, isobutyl alcohol, isopropyl alcohol or methylcyclohexanol, an ester, for example, methyl acetate, butyl acetate, isobutyl acetate, isopropyl acetate, ethyl lactate or glycol acetate, a glycol ether, for example, glycol dimethyl ether, glycol monoethyl ether or dioxane, an aromatic hydrocarbon, for example, benzene, toluene, xylene, cresol or chlorobenzene, a chlorinated hydrocarbon, for example, methylene chloride, ethylene chloride, carbon tetrachloride, chloroform, ethylene chlorohydrin or dichlorobenzene, N,N-dimethylformamide, hexane or water can be used.

The solvent do not always need to be 100% pure and, in addition to the main component, an impurity, for example, an isomer, an unreacted material, a side reaction product, a decomposed product, an oxide or water may be contained. However, the content of the impurity is preferably 30% or less, and more preferably 10% or less. Of the solvents, an alcohol, for example, methanol, ethanol or isopropyl alcohol, water, cyclohexanone, methyl ethyl ketone and butyl acetate are preferably used individually or in combination.

It is also possible to incorporate a filler into the coating solution for the smoothing layer in order to obtain the desired surface property. The largest diameter of the filler is preferably 50 nm or less. When the largest diameter exceeds 50 nm, it may cause dropout (DO) in some cases. The content of the filler is preferably 50% by weight or less, more preferably 30% by weight or less, and particularly preferably 25% by weight or less, based on the polymer.

It is desired that the smoothing layer is stable to a coating solution for magnetic layer. Accordingly, the elution amount of the smoothing layer in a mixed solution of methyl ethyl ketone (MEK)/cyclohexanone (1/1) is preferably from 0.0 to 0.4 mg/cm², and more preferably from 0.0 to 0.2 mg/cm².

The Young's modulus of the smoothing layer is preferably from 10 to 90%, more preferably from 20 to 80%, and still more preferably from 30 to 70%, taking the Young's modulus of the nonmagnetic support as 100%. Specifically, the Young's modulus of the smoothing layer is preferably from 1 to 8 GPa, more preferably from 2 to 7 GPa, and still more preferably from 3 to 6 GPa.

By arranging the Young's modulus of the smoothing layer in the above-described range, the cushioning effect arises in the smoothing layer and the occurrence of excessive abrasion of a head is prevented even when inorganic powder, for example, an abrasive having a large average particle size is used in the magnetic layer. Further, the effect of penetrating the abrasive in the direction of thickness also arises by the calendering treatment, thereby contributing to the prevention of abrasion of head.

According to the invention, therefore, the excessive abrasion of head can be prevented in the case wherein an average particle size (d) of at least one kind of the inorganic powder contained in the magnetic layer and thickness (t) of the magnetic layer satisfy the relation d≧t.

### 3. Magnetic Layer and Nonmagnetic Layer

### <Binder>

The binder for use in a magnetic layer, nonmagnetic layer or back layer according to the invention includes a conventionally known thermoplastic resin, thermosetting resin or reactive resin and a mixture thereof. The thermoplastic resin includes, for example, a homopolymer or copolymer containing a constituting unit derived, for example, from vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal or a vinyl ether, a polyurethane resin, and a variety of rubber series The thermosetting resin or reactive resin includes, for example, a phenolic resin, an epoxy resin, a thermosetting polyurethane resin, a urea resin, a melamine resin, an alkyd resin, a reactive acrylic resin, a formaldehyde resin, a silicone resin, an epoxy-polyamide resin, a mixture of a polyester resin and an isocyanate prepolymer, a mixture of a polyester polyol and a polyisocyanate and a mixture of a polyurethane and a polyisocyanate. The thermoplastic resin, thermosetting resin and reactive resin are described in greater detail in Plastic Handbook, Asakura Publishing Co., Ltd.

When an electron beam-curable resin is used in the magnetic layer, not only the coating layer strength increases to improve the durability but also the surface of the layer is smoothened to further increase the electromagnetic conversion characteristics. Examples of the resins and the production method thereof are described in detail in JP-A-62-256219.

The above-described resins can be used individually or in combination. Of the resins, a polyurethane resin is preferably used. A polyurethane resin which is obtained by reacting a cyclic structural compound, for example, hydrogenated bisphenol A or a polypropylene oxide adduct of hydrogenated bisphenol A, a polyol including an alkylene oxide chain and having a molecular weight of 500 to 5,000, a polyol including a cyclic structure and having a molecular weight of 200 to 500 as a chain extender, and an organic diisocyanate and to which a polar group is introduced, a polyurethane resin which is obtained by reacting an aliphatic dibasic acid, for example, succinic acid, adipic acid or sebacic acid, a polyesterpolyol derived from an aliphatic diol including a branched alkyl side chain but not a cyclic structure, for example, 2,2-dimethyl-1,3-propanediol, 2-ethyl-2-butyl-1,3-propanediol or 2,2-diethyl-1,3-propanediol, an aliphatic diol including a branched alkyl side chain having 3 or more carbon atoms, for example, 2-ethyl-2-butyl-1,3-propanediol or 2,2-diethyl-1,3-propanediol as a chain extender, and an organic diisocyanate compound and to which a polar group is introduced, or a polyurethane resin which is obtained by reacting a cyclic structural compound, for example, a dimerdiol, a polyol compound including a long chain alkyl chain, and an organic diisocyanate compound and to which a polar group is introduced is more preferably used.

The average molecular weight of the polar group-containing polyurethane resin for use in the invention is preferably from 5,000 to 100,000, and more preferably from 10,000 to 50,000. When the average molecular weight of the polyurethane resin is 5,000 or more, the magnetic coating layer obtained is prevented from degradation of mechanical strength, for example, embrittlement and the durability of the magnetic recording medium is not adversely affected. On the other hand, when the average molecular weight of the polyurethane resin is 100,000 or less, the dispersibility is good because the solubility in a solvent does not decrease. Further, since the viscosity of the coating composition at the predetermined concentration does not increase, the workability is good and the handling is easy.

Examples of the polar group included in the polyurethane resin include —COOM, —SO₃M, —OSO₃M, —P═O(OM)₂, —O—P═O(OM)₂ (wherein M represents a hydrogen atom or an alkali metal base), —OH, —NR₂, —N⁺R₃ (wherein R represents a hydrocarbon group), an epoxy group, —SH and —CN. At least one of the polar groups is introduced by copolymerization or addition reaction. Further, when the polar group-containing polyurethane resin has an OH group, it is preferable to have a branched OH group from the standpoint of curing property and durability. It is more preferable to have 2 to 40 branched OH groups per molecule and still more preferable to have 3 to 20 branched OH groups per molecule. The amount of the polar group is preferably from 10⁻¹ to 10⁻⁸ mol/g, more preferably from 10⁻² to 10⁻⁶ mol/g.

Specific examples of the binder include VAGH, VYHH, VMCH, VAGF, VAGD, VROH, VYES, VYNC, VMCC, XYHL, YXSG, PKHH, PKHJ, PKHC and PKFE (produced by Dow Chemical Co.), MPR-TA, MPR-TA5, MPR-TAL, MPR-TSN, MPR-TMF, MPR-TS, MPR-TM and MPR-TAO (produced by Nissin Chemical Industry Co., Ltd.), 1000W, DX80, DX81, DX82, DX83 and 100FD (produced by Denki Kagaku Kogyo Kabushiki Kaisha), MR-104, MR-105, MR-110, MR-100, MR-555 and 400X-110A (produced by Nippon Zeon Co., Ltd.), Nippollan N2301, N2302 and N2304 (produced by Nippon Polyurethane Industry Co., Ltd.), Pandex T-5105, T-R3080 and T-5201, Burnock D-400 and D-210-80, Crisvon 6109 and 7209 (produced by Dainippon Ink and Chemicals Inc.), Vylon UR8200, UR8300, UR8700, RV530 and RV280 (produced by Toyobo Co., Ltd.), Daipheramine 4020, 5020, 5100, 5300, 9020, 9022 and 7020 (produced by Dainichiseika Color and Chemicals Mfg. Co., Ltd.), MX5004 (produced by Mitsubishi Chemical Corp.), Sunprene SP-150 (produced by Sanyo Chemical Industries, Ltd.), and Salan F310 and F210 (produced by Asahi Kasei Corp.) The amount of the binder for use in the magnetic layer according to the invention is preferably from 5 to 50% by weight, more preferably from 10 to 30% by weight, based on the amount of the ferromagnetic powder. The amount of the binder for use in the nonmagnetic layer according to the invention is preferably from 5 to 50% by weight, more preferably from 10 to 30% by weight, based on the amount of the nonmagnetic powder. When a polyurethane resin is used, the amount of the polyurethane resin is preferably from 2 to 20% by weight, and it is preferred that a polyisocyanate is used in an amount of 2 to 20% by weight in combination with the polyurethane resin. For instance, when head corrosion is caused with a slight amount of chlorine due to dechlorination, it is also possible to use the polyurethane resin alone or a combination of the polyurethane resin and the isocyanate alone. When a vinyl chloride resin is used as other resin, the amount of the vinyl chloride resin is preferably from 5 to 30% by weight. When the polyurethane resin is used in the invention, it is preferred that the polyurethane resin has glass transition temperature from −50 to 150° C., preferably from 0 to 100° C., breaking extension from 100 to 2,000%, breaking stress from 0.49 to 98 MPa (0.05 to 10 kg/mm², and a yielding point from 0.49 to 98 MPa (0.05 to 10 kg/mm².

### <Ferromagnetic Powder>

In the magnetic recording medium according to the invention, it is preferred to use as the ferromagnetic powder, an acicular ferromagnetic material having an average major axis length of 20 to 50 nm, a tabular magnetic material having an average tabular diameter of 10 to 50 nm or a spherical or oval magnetic material having an average diameter of 10 to 50 nm. These ferromagnetic materials will be described in order below.

### (1) Acicular Ferromagnetic Material

As the ferromagnetic powder for use in the magnetic recording medium according to the invention, an acicular ferromagnetic material having an average major axis length of 20 to 50 nm can be used. As the acicular ferromagnetic material, acicular ferromagnetic metal powder, for example, ferromagnetic cobalt-containing iron oxide powder or a ferromagnetic alloy powder is exemplified. The BET specific surface area (SBET) is preferably from 40 to 80 m²/g, and more preferably from 50 to 70 m²/g. The crystallite size is preferably from 12 to 25 nm, more preferably from 13 to 22 nm, and particularly preferably from 14 to 20 nm. The major axis length is from 20 to 50 nm, and preferably from 20 to 40 nm.

The acicular ferromagnetic powder includes Fe, Fe—Co, Fe—Ni and Co—Ni—Fe each containing yttrium. The content of yttrium in the ferromagnetic powder is preferably from 0.5 to 20 atom %, more preferably from 5 to 10 atom %, in terms of a ratio of yttrium atom to iron atom (Y/Fe). When the yttrium content is less than 0.5 atom %, since the high saturation magnetization (σs) of the ferromagnetic powder can not be achieved, the magnetic characteristics decrease, resulting in the degradation of the electromagnetic conversion characteristics. On the other hand, when the yttrium content is more than 20 atom %, since the content of iron decreases, the magnetic characteristics decrease, resulting in the degradation of the electromagnetic conversion characteristics. The ferromagnetic powder may further contain aluminum, silicon, sulfur, scandium, titanium, vanadium, chromium, manganese, copper, zinc, molybdenum, rhodium, palladium, tin, antimony, boron, barium, tantalum, tungsten, rhenium, gold, lead, phosphorus, lanthanum, cerium, praseodymium, neodymium, tellurium, bismuth or the like in the range of 20 atom % or less based on 100 atom % of iron. The ferromagnetic powder may contain a small amount of water, a hydroxide or an oxide.

An example of the preparation method of cobalt and yttrium-containing ferromagnetic powder for use in the invention is described below.

In the example, iron oxyhydroxide obtained by bubbling oxidizing gas through an aqueous suspension containing an iron (II) salt and an alkali is used as a starting material.

The iron oxyhydroxide is preferably α-FeOOH. There are two processes of preparing α-FeOOH. According to the first process, an iron (II) salt is neutralized with an alkali hydroxide to obtain an aqueous suspension of Fe(OH)₂, and to the suspension is bubbled oxidizing gas to obtain acicular α-FeOOH. According to the second process, an iron (II) salt is neutralized with an alkali carbonate to obtain an aqueous suspension of FeCO₃, and to the suspension is bubbled oxidizing gas to obtain spindle-shaped α-FeOOH. The iron oxyhydroxide is preferably obtained by reacting an aqueous solution of an iron (II) salt and an alkali aqueous solution to obtain an aqueous solution containing iron (II) hydroxide, which is then oxidized, for example, with air oxidation. To the aqueous solution of the iron (II) salt, a salt, for example, a nickel salt, an alkaline earth metal salt (for example, a calcium salt, a barium salt or a strontium salt), a chromium salt, a zinc salt may be added. By appropriately selecting the salt to use, the shape of particle, for example, an axial ratio can be controlled.

The iron (II) salt preferably includes, for example, iron (II) chloride and iron (II) sulfate. The alkali preferably includes, for example, sodium hydroxide, aqueous ammonia, ammonium carbonate and sodium carbonate. The salt which is added to the reaction system includes preferably a chloride, for example, nickel chloride, calcium chloride, barium chloride, strontium chloride, chromium chloride or zinc chloride.

With respect to the introduction of cobalt, an aqueous solution of a cobalt compound, for example, cobalt sulfate or cobalt chloride is mixed with the iron oxyhydroxide suspension while stirring to prepare a suspension of iron oxyhydroxide containing cobalt prior to the introduction of yttrium. Yttrium is then introduced by adding an aqueous solution containing a yttrium compound to the suspension of iron oxyhydroxide containing cobalt, followed by mixing with stirring.

An element other than yttrium, for example, neodymium, samarium, praseodymium or lanthanum may be introduced into the ferromagnetic powder according to the invention. The element can be introduced using a salt thereof, for example, a chloride, e.g., yttrium chloride, neodymium chloride, samarium chloride, praseodymium chloride or lanthanum chloride or a nitrate, e.g., neodymium nitrate or gadolinium nitrate. The elements may be used in combination of two or more thereof.

The coercive force (Hc) of the ferromagnetic powder is preferably from 159.2 to 238.8 kA/m (2,000 to 3,000 Oe), and more preferably from 167.2 to 230.8 kA/m (2,100 to 2,900 Oe).

The saturation magnetic flux density thereof is preferably from 150 to 300 mT (1,500 to 3,000 G), and more preferably from 160 to 290 mT (1,600 to 2,900 G). The saturation magnetization (σs) thereof is preferably from 100 to 170 A·m²/kg (100 to 170 emu/g) and more preferably from 110 to 160 A·m²/kg (110 to 160 emu/g).

The SFD (switching field distribution) of the ferromagnetic powder itself is preferably as small as possible, specifically 0.8 or smaller. When the SFD is smaller than 0.8, the electromagnetic conversion characteristics is good, output is high, magnetization reversal is sharp and a peak shift is small so that the magnetic powder is advantageous for high density digital magnetic recording. In order to make the coercivity distribution small, there are methods, for example, of improving size distribution of goethite in the ferromagnetic metal powder, using mono-dispersed α-Fe₂O₃ particle and preventing sintering of particles.

### (2) Tabular Magnetic Material

The tabular magnetic material having an average tabular diameter of 10 to 50 nm which can be used in the invention is preferably hexagonal ferrite powder.

The hexagonal ferrite includes barium ferrite, strontium ferrite, lead ferrite, calcium ferrite, and a substitution compound thereof, for example, Co-substitution compound thereof. Specific examples thereof include barium ferrite and strontium ferrite of magnetoplumbite type, magnetoplumbite type ferrite coated its surface with spinel and barium ferrite and strontium ferrite of magnetoplumbite type containing a spinel phase in part. The ferrite may contain an atom, for example, Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and Zn in addition to the predetermined atoms. Ordinarily, ferrites containing elements, for example, Co—Zn, Co—Ti, Co—Ti—Zr, Co—Ti—Zn, Ni—Ti—Zn, Nb—Zn—Co, Sb—Zn—Co or Nb—Zn can be used. The ferrite may contain a specific impurity according to the starting material or the process of preparation.

The particle size is preferably from 10 to 50 nm, more preferably from 10 to 40 nm, and particularly preferably from 10 to 30 nm, in terms of an average tabular diameter.

When the reproduction is performed using a magnetoresistive head, the tabular diameter is preferably 40 nm or less for the necessity to reduce noise. When the tabular diameter is in the above-described range, stable magnetization is expected without thermal fluctuation. Further, since the noise is reduced, it is suitable for high density magnetic recording.

The average tabular ratio is preferably from 1 to 15, and more preferably from 2 to 7. In the above-described range, the orientation is sufficient, stacking of particles each other hardly occurs and noise is reduced. In the above-described particle size range, the specific surface area by BET method is from 10 to 200 m²/g. The specific surface area approximately corresponds to the value arithmetically calculated from the tabular diameter and the tabular thickness of the particle. The crystallite size is preferably from 50 to 450 angstrom, and more preferably from 100 to 350 angstrom. It is ordinarily preferable that the distributions of tabular diameter and tabular thickness of the particle are narrow. Although the distribution is not normal in many cases, a ratio of standard deviation (a) to an average size (a/average powder size) by calculation is from 0.1 to 2.0. In order to make the particle size distribution sharp, as well as making the reaction system for particle formation as uniform as possible, the resulting particle is subjected to a distribution improving treatment. For instance, a method of selectively dissolving superfine particles in an acid solution is known.

The magnetic material can be formed to have a coercive force Hc of about 39.8 to about 398 kA/m (500 to 5,000 Oe). Although a higher Hc is more advantageous for high density recording, the Hc is limited by the ability of recording head. The Hc is preferably from about 63.7 to 318.4 kA/m (800 to 4,000 Oe), and more preferably from 119.4 to 278.6 kA/m (1,500 to 3,500 Oe). When the saturation magnetization of the head exceeds 1.4 Tesla, the Hc is preferably 159.2 kA/m (2,000 Oe) or higher.

The Hc can be controlled, for example, by the particle size (tabular diameter and tabular thickness), the kind and amount of the constituent element, the substitution site of the element or the reaction condition of particle formation. The saturation magnetization as is from 40 to 80 A·m²/kg (40 to 80 emu/g). Although a higher as is more preferable, the saturation magnetization tends to decrease as the particle size becomes smaller. For the purpose of improving the as, it is well known to combine a magnetoplumbite ferrite with a spinel ferrite or to select the kind and amount of the constituent element. It is also possible to use a W-type hexagonal ferrite.

In the dispersion of the magnetic material (magnetic powder), it is performed to treat the surface of the magnetic particle with a substance compatible with a dispersing medium or a polymer. The surface treating substance includes an organic compound and an inorganic compound. Typical examples thereof include an oxide or a hydroxide of Si, Al or P, a variety of silane coupling agents and a variety of titanium coupling agents. The amount of the surface treating substance is preferably from 0.1 to 10% based on the magnetic material. The pH of the magnetic material is also important for the dispersion. The pH is preferably from about 4 to about 12. From the standpoint of chemical stability and storage stability of the magnetic recording medium, the pH of about 6 to about 10 is selected while the optimal value depends on the dispersing medium and polymer to be used. Water contained in the magnetic material also has an effect on the dispersion. While the optimal value depends on the dispersing medium and polymer to be used, the water content is preferably from 0.01 to 2.0%.

Methods for the preparation of hexagonal ferrite includes, for example, (1) a glass crystallization method wherein barium oxide, iron oxide, a metal oxide with which iron is substituted and a glass forming substance (for example, boron oxide) were mixed in a ratio for forming the desired ferrite composition, molten, rapidly cooled to form an amorphous solid, subjected to re-heat treatment, washed and ground to obtain a barium ferrite crystal powder, (2) a hydrothermal method wherein a solution of barium ferrite-forming metal salts is neutralized with an alkali, after removing the by-product, heated in a liquid phase at 100° C. or higher, washed, dried and ground to obtain a barium ferrite crystal powder, and (3) a coprecipitation method wherein a solution of barium ferrite-forming metal salts is neutralized with an alkali, after removing a by-product, dried, treated at 1,100° C. or lower and ground to obtain a barium ferrite crystal powder. However, the method according to the invention should not be construed as being limited thereto.

### (3) Spherical or Oval Magnetic Material

As the spherical or oval magnetic material, iron nitride ferromagnetic powder having Fe₁₆N₂ as the main phase is preferable. The magnetic material may contain an atom, for example, Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge or Nb in addition to the atoms of Fe and N. The content of N to Fe is preferably from 1.0 to 20.0 atom %.

The iron nitride is preferably a spherical shape or an oval shape. The average acicular ratio is preferably from 1 to 2. The BET specific surface area (SBET) is preferably from 30 to 100 m²/g and more preferably from 50 to 70 m²/g. The crystallite size is preferably from 12 to 25 nm and more preferably from 13 to 22 nm.

The saturation magnetization as is preferably from 50 to 200 A·m²/kg (emu/g), and more preferably from 70 to 150 A·m²/kg (emu/g).

The average powder size (average diameter or average major axis length) of the spherical or oval ferromagnetic material is preferably from 10 to 50 nm, more preferably from 15 to 45 nm, and particularly preferably from 25 to 45 nm.

In the present specification, the size of magnetic material (hereinafter also referred to as “powder size”) is determined from high-resolution transmission electron micrograph. Specifically, (1) when the shape of the powder is acicular, spindle-shaped, column-shaped (provided that its height is larger than the maximum major diameter of its bottom face) or the like, the powder size is represented by length of the major axis constituting the powder, that is, major axis length, (2) when the shape of the powder is tabular or column-shaped (provided that its thickness or height is smaller than the maximum major diameter of its tabular face or bottom face), the powder size is represented by the maximum major diameter of its tabular face or bottom face, and (3) when the shape of the powder is spherical, polyhedral, unspecified shaped or the like, and the major axis constituting the powder can not be identified from the shape, the powder size is represented by a circle equivalent diameter. The circle equivalent diameter means that determined by a spherical projection method.

The average powder size of the powder is an arithmetic mean of the above-described powder size which is obtained by conducting the above-described measurement with respect to about 350 primary particles. The primary particle means an independent particle without aggregation.

The average acicular ratio of the powder indicates an arithmetic mean of values of a ratio of (major axis length/minor axis length) of respective powders obtained by measurement of the length of minor axis, that is, minor axis length of the powder according to the above-described method. The minor axis length indicates the length of minor axis constituting the powder in the case (1) according to the definition of powder size. In the case (2) according to the definition of powder size, it indicates the thickness or height of the powder. In the case (3) according to the definition of powder size, the ratio of (major axis length/minor axis length) is considered as 1 for convenience, because the major axis and minor axis can not be identified.

When the shape of the power is specified, for example, in the case (1) according to the definition of powder size, the average powder size is called an average major axis length. In the case (2) according to the definition of powder size, the average powder size is called an average tabular diameter and the arithmetic mean of a ratio of (major axis length/thickness or height) is called an average tabular ratio. In the case (3) according to the definition of powder size, the average powder size is called an average diameter. In the measurement of the powder size, a value of a ratio of standard deviation/average in percentage terms is defined as a coefficient of variation.

By arranging the average powder size of the magnetic material in the preferable range (from 25 to 50 nm in the acicular ferromagnetic material, from 10 to 50 nm in the tabular magnetic material, or from 10 to 50 nm in the spherical or over magnetic material) the surface property of the magnetic recording medium is improved and the excellent electromagnetic conversion characteristics can be obtained because the output at the signal reproduction is large and the particle noise at the signal regeneration is small.

Further, by arranging the average powder size of the magnetic material in the preferable range, since dispersibility of the magnetic material is improved, the demagnetization due to thermal fluctuation is restrained, resulting in improvement of the electromagnetic conversion characteristics. When the average powder size exceeds the upper limit of the preferable range, the surface property becomes coarse to tend to cause decrease of the output and increase of the particle noise, resulting in the possibility of deterioration of the electromagnetic conversion characteristics.

To the magnetic layer according to the invention, additives can be added, if desire. Examples of the additive include an abrasive, a lubricant, a dispersing agent or dispersing auxiliary agent, an antifungal, an antistatic agent, an antioxidant, a solvent and carbon black.

Specific examples of the additive include molybdenum disulfide, tungsten disulfide, graphite, boron nitride, graphite fluoride, a silicone oil, a polar group-containing silicone, a fatty acid-modified silicone, a fluorine-containing silicone, a fluorine-containing alcohol, a fluorine-containing ester, a polyolefin, a polyglycol, a polyphenyl ether, an aromatic ring-containing organic phosphonic acid, for example, phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid or nonylphenylphosphonic acid, an alkali metal salt thereof, an alkylphosphonic acid, for example, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid or isoeicosylphosphonic acid, an alkali metal salt thereof, an aromatic phosphoric acid ester, for example, phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, toluyl phosphate, xylyl phosphate, ethylphenyl phosphate, cumenyl phosphate, propylphenyl phosphate, butylphenyl phosphate, heptylphenyl phosphate, octylphenyl phosphate or nonylphenyl phosphate, an alkali metal salt thereof, an alkyl phosphate, for example, octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate or isoeicosyl phosphate, an alkali metal salt thereof, an alkylsulfonic ester, an alkali metal salt thereof, a fluorine-containing alkylsulfuric ester, an alkali metal salt thereof, a monobasic fatty acid having from 10 to 24 carbon atoms which may have an unsaturated bond or may be branched, for example, lauric acid, myristic acid, palmitic acid, stearic acid, behenic acid, oleic acid, linoleic acid, linolenic acid, elaidic acid or erucic acid, a metal salt thereof, a mono-fatty acid ester, di-fatty acid ester or polyvalent fatty acid ester prepared from a monobasic fatty acid having from 10 to 24 carbon atoms which may have an unsaturated bond or may be branched and at least one of a mono-valent to hexa-valent alcohol having from 2 to 22 carbon atoms which may have an unsaturated bond or may be branched, an alkoxyalcohol having from 12 to 22 carbon atoms which may have an unsaturated bond or may be branched and a monoalkyl ether of an alkylene oxide polymer, for example, butyl stearate, octyl stearate, amyl stearate, isooctyl stearate, octyl myristate, butyl laurate, butoxyethyl stearate, anhydrosorbitol monostearate, anhydrosorbitol distearate or anhydrosorbitol tristearate, an aliphatic acid amide having from 2 to 22 carbon atoms, and an aliphatic amine having from 8 to 22 carbon atoms. The above-described compounds may have an alkyl, aryl or aralkyl group substituted with a group other than the hydrocarbon group, for example, a nitro group, F, Cl, Br or a halogenated hydrocarbon group (e.g., CF₃, CCl₃ or CBr₃) as well as the above-described hydrocarbon group.

The magnetic layer can also contain a surfactant including a nonionic surfactant, for example, an alkylene oxide type, a glycerol type, a glycidol type or an alkylphenol ethylene oxide adduct, a cationic surfactant, for example, a cyclic amine, an ester amide, a quaternary ammonium salt, a hydantoin derivative, a heterocyclic compound, a phosphonium salt or a sulfonium salt, an anionic surfactant containing an acidic group, for example, a carboxyl group, a sulfonic acid group or a sulfuric ester group, and an amphoteric surfactant, for example, an amino acid, an aminosulfonic acid, an amino alcohol sulfuric or phosphoric ester or an alkyl betaine. These surfactants are described in detail in Kaimenkasseizai Binran (Handbook of Surfactants), published by Sangyo Tosho Co., Ltd.

The above-described dispersing agent, lubricant and the like do not always need to be pure and, in addition to the main component, an impurity, for example, an isomer, an unreacted material, a side reaction product, a decomposed product or an oxide may be contained. The proportion of the impurity is preferably 30% by weight or less, and more preferably 10% by weight or less.

Specific examples of the additive include NAA-102, castor oil-hardened fatty acid, NAA-42, Cation SA, Nymeen L-201, Nonion E-208, Anon BF and Anon LG each produced by NOF Corp., FAL 205 and FAL 123 each produced by Takemoto Oil and Fat Co., Ltd., Enujelv OL produced by New Japan Chemical Co., Ltd., TA-3 produced by Shin-Etsu Chemical Industry Co., Ltd., Armid P and Duomeen TDO each Produced by Lion Corp., BA 41G Produced by Nisshin Oillio Group, Ltd., Profan 2012E, Newpole PE 61 and Ionet MS400 each produced by Sanyo Chemical Industries, Ltd.

The organic solvent for use in the magnetic layer includes known organic solvents. As the organic solvent, a ketone, for example, methyl ethyl ketone, methyl isobutyl ketone, diisobutyl ketone, cyclohexanone, isophorone or tetrahydrofuran, an alcohol, for example, methanol, ethanol, propanol, butanol, isobutyl alcohol, isopropyl alcohol or methylcyclohexanol, an ester, for example, methyl acetate, butyl acetate, isobutyl acetate, isopropyl acetate, ethyl lactate or glycol acetate, a glycol ether, for example, glycol dimethyl ether, glycol monoethyl ether or dioxane, an aromatic hydrocarbon, for example, benzene, toluene, xylene, cresol or chlorobenzene, a chlorinated hydrocarbon, for example, methylene chloride, ethylene chloride, carbon tetrachloride, chloroform, ethylenechlorohydrin or dichlorobenzene, N,N-dimethylformamide and hexane can be used in an appropriate ratio.

The organic solvent do not always need to be 100% pure and, in addition to the main component, an impurity, for example, an isomer, an unreacted material, a side reaction product, a decomposed product, an oxide or water may be contained. The impurity content is preferably 30% by weight or less, and more preferably 10% by weight or less. The organic solvent used in the formation of the magnetic layer and that used in the formation of the nonmagnetic layer are preferably the same in the kind but may be different in the amount. It is important to use a solvent having high surface tension (for example, cyclohexanone or dioxane) in the nonmagnetic layer to improve coating stability. Specifically, it is important that the arithmetic mean of the solvent composition of the upper magnetic layer is not lower than that of the lower nonmagnetic layer. In order to improve the dispersibility, the solvent preferably has somewhat high polarity. It is preferred that the solvent composition contains at least 50% of a solvent having a dielectric constant of 15 or higher. The solubility parameter is preferably from 8 to 11.

The kind and amount of the dispersing agent, lubricant or surfactant for use in the magnetic layer and the nonmagnetic layer described hereinafter according to the invention can be appropriately decided according to need. Some examples are described below, but the invention should not be construed as being limited thereto. Since the dispersing agent has a property of being adsorbed or bonded to a substance through its polar group, it is adsorbed or bonded through the polar group mostly to the surface of ferromagnetic powder in the magnetic layer or the surface of nonmagnetic powder in the nonmagnetic layer. It is assumed that, after once being absorbed to the surface of metal or metal compound, the dispersing agent, for example, an organic phosphorus compound is hardly desorbed therefrom. Since the surface of the ferromagnetic powder or nonmagnetic powder treated with the dispersing agent appears to be covered with an alkyl group, an aromatic group or the like, the compatibility of the ferromagnetic powder or nonmagnetic powder with a binder resin component is increased and the dispersion stability of the ferromagnetic powder or nonmagnetic powder is also improved. Since the lubricant exists in a free state, bleeding of the lubricant is controlled by using fatty acids having different melting points between the magnetic layer and the nonmagnetic layer or bleeding of the lubricant is controlled by using esters different in boiling point or polarity between the magnetic layer and the nonmagnetic layer. The stability of coating is improved by adjusting the amount of the surfactant. The amount of the lubricant in the nonmagnetic layer is increased to improve the lubricating effect. All or part of the additive may be added at any stage of the preparation of coating solution for magnetic layer or nonmagnetic layer. For instance, the additive can be mixed with the ferromagnetic powder before kneading, added in the kneading step of the ferromagnetic powder, the binder and the solvent, be added during the dispersing step, be added after the dispersing step or be added immediately before coating.

Further, carbon black may be added to the magnetic layer according to the invention, if desired.

As the carbon black, for example, furnace black for rubber, thermal black for rubber, carbon black for color or acetylene black can be used. With the carbon black for use in the radiation-curable layer, the characteristics described below should be optimized according to the effect desired. A combined use of carbon black is effective in some cases.

The specific surface area of the carbon black is preferably from 100 to 500 m²/g, and more preferably from 150 to 400 m²/g, and the oil (DBT) absorption amount thereof is preferably from 20 to 400 ml/100 g, and more preferably from 30 to 200 ml/100 g. The particle size of the carbon black is preferably from 5 to 80 μm, more preferably from 10 to 50 μm, and further more preferably from 10 to 40 μm. The pH of the carbon black is preferably from 2 to 10, the water content thereof is preferably from 0.1 to 10%, and the tap density thereof is preferably from 0.1 to 1 g/ml.

Specific examples of the carbon black for use in the invention include BLACKPEARLS 2000, 1300, 1000, 900, 800, 880 and 700 and VULCAN XC-72 each produced by Cabot Corp., #3050B, #3150B, #3250B, #3750B, #3950B, #950, #650B, #970B, #850B, MA-600, MA-230, #4000 and #4010 each produced by Mitsubishi Chemical Corp., CONDUCTEX SC, RAVEN 8800, 8000, 7000, 5750, 5250, 3500, 2100, 2000, 1800, 1500, 1255 and 1250 each produced by Columbian Carbon, and Ketjen Black EC produced by Ketjen Black International Co..

Carbon black surface treated, for example, with a dispersing agent, resin-grafted carbon black or carbon black with its surface partially graphitized may be used. The carbon black may previously been dispersed in a binder before being added to a coating composition. With respect to the carbon black for use in the invention, reference can be made, for example, to Carbon Black Binran (Handbook of Carbon Black), compiled by Carbon Black Kyokai.

The carbon blacks can be used individually or in combination. The carbon black is preferably used in an amount of 0.1 to 30% by weight based on the weight of magnetic material. The carbon black serves for prevention of static charge, reduction of frictional coefficient, provision of light-shielding property, improvement of film strength and the like. These functions depend on the species of carbon black. Accordingly, it is obviously possible to determine the kind, amount and combination of the carbon black used in the magnetic layer according to the intended use with reference to the above-described characteristics, for example, particle size, oil absorption amount, conductivity or pH. The optimization should be made in each layer.

The inorganic powder for use in the nonmagnetic layer is described below. As the inorganic powder, a known material having a Mohs hardness of 6 or more, for example, α-alumina having an α-phase content of 70% or more, β-alumina, silicon carbide, chromium oxide, cerium oxide, β-iron oxide, corundum, synthetic diamond, silicon nitride, silicon carbide, titanium carbide, titanium oxide, silicon dioxide or boron nitride can be mainly used individually or in combination. Further, a composite of the abrasives (abrasive surface-treated with another abrasive) may be used.

While a compound or element other than the main component may be included in the abrasive sometimes, the effect is not changed to the extent that the content of the main component is 90% or more. The particle size of the abrasive is preferably in a range of 0.15 to 0.30 μm, more preferably in a range of 0.15 to 0.25 μm, and most preferably in a range of 0.18 to 0.25 μm. In particular, in order to increase the electromagnetic conversion characteristics, it is preferred that the particle size distribution thereof is narrow. It is also possible to combine abrasives having different particle sizes from each other in order to improve the durability, if possible. The same effect can be achieved by using a single abrasive having a broad particle size distribution.

The number of abrasive protruded through the surface of the magnetic layer as defined in the example hereinafter is preferably from 50 to 200/100 μm², more preferably from 70 to 170/100 μm², and particularly preferably from 100 to 150/100 μm².

The tap density, water content, pH and specific surface area of the abrasive are preferably from 0.3 to 2 g/ml, form 0.1 to 5%, from 2 to 11, and from 1 to 30 m²/g, respectively. The shape of the abrasive may be any of acicular, spherical and die-like shapes. The abrasive having a shape partially including an edge is preferable because of high abradability.

Specific examples of the abrasive include AKP-12, AKP-15, AKP-20, AKP-30, AKP-50, HIT-20, HIT-30, HIT-55, HIT-60, HIT-70, HIT-80 and HIT-100 (produced by Sumitomo Chemical Co., Ltd.), ERC-DBM, HP-DBM and HPS-DBM (produced by Reynolds International Inc.), WA10000 (produced by Fujimi Inc.), UB20 (produced by Uemura and Co., Ltd), G-5, Chromex U2 and Chromex U1 (produced by Nippon Chemical Industrial Co., Ltd.), TF100 and TF140 (produced by Toda Kogyo Corp.), Betarandom Ultrafine (produced by Ibiden Co., Ltd.) and B-3 (produced by Showa Mining Co., Ltd.).

The surface roughness of the magnetic layer is preferably from 1.5 to 3.0 nm, more preferably from 1.8 to 2.8 nm, and still more preferably from 2.0 to 2.5 nm in terms of centerline average surface roughness (Ra). The centerline average surface roughness (Ra) can be measured by an atomic force microscope (AFM).

### Nonmagnetic Layer

The magnetic recording material according to the invention has at least one nonmagnetic layer containing nonmagnetic powder dispersed in a binder between the nonmagnetic support and the magnetic layer. The same binder for use in the magnetic layer can also be used in the nonmagnetic layer.

The nonmagnetic powder for use in the nonmagnetic layer may be made of either an organic material or an inorganic material. In the nonmagnetic layer, carbon black may also be used together with the nonmagnetic powder, if desired.

### (Nonmagnetic Powder)

In the nonmagnetic layer, although magnetic powder may be used as long as the layer is substantially nonmagnetic, it is preferred to use nonmagnetic powder. The nonmagnetic powder for use in the nonmagnetic layer may be made of either an organic material or an inorganic material. Also, carbon black or the like can be used. The inorganic nonmagnetic material includes, for example, metal, metal oxide, metal carbonate, metal sulfate, metal nitride, metal carbide and metal sulfide.

Specific examples of the inorganic nonmagnetic material include titanium oxide (for example, titanium dioxide), cerium oxide, tin oxide, tungsten oxide, ZnO, ZrO₂, SiO₂, Cr₂O₃, α-alumina having an α-phase content of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide and titanium carbide. The inorganic nonmagnetic materials may be used individually or in combination. Among them, a-iron oxide and titanium oxide are preferable.

The shape of the nonmagnetic powder may be any of acicular, spherical, polygonal and tabular shapes.

The crystallite size of the nonmagnetic powder is preferably from 4 nm to 1 μm, more preferably from 40 to 100 nm. The crystallite size in the range of 4 nm to 1 μm is preferable because the dispersion thereof is not difficult and the appropriate surface roughness is secured.

The average particle size of the nonmagnetic powder is preferably from 5 nm to 2 μm. If desired, the nonmagnetic powder different in the average particle size may be used in combination, or a single kind of the nonmagnetic powder having a broad particle size distribution may be used to exert the same effect. More preferable average particle size of the nonmagnetic powder is from 10 to 200 nm. The average particle size of 5 nm to 2 μm is preferable because the dispersion thereof is good and the appropriate surface roughness is secured.

The specific surface area of the nonmagnetic powder is preferably from 1 to 100 m²/g, preferably from 5 to 70 m²/g, and more preferably from 10 to 65 m²/g The specific surface area of 1 to 100 m²/g is preferable because the appropriate surface roughness is secured and the nonmagnetic powder can be dispersed in the desired amount of binder.

The oil absorption amount using dibutyl phthalate (DBP) of the nonmagnetic powder is preferably from 5 to 100 ml/100 g, more preferably from 10 to 80 ml/100 g, and still more preferably from 20 to 60 ml/100 g.

The specific gravity of the nonmagnetic powder is preferably from 1 to 12, and more preferably from 3 to 6. The tap density of the nonmagnetic powder is preferably from 0.05 to 2 g/ml, and more preferably from 0.2 to 1.5 g/ml. When the tap density is in the range from 0.05 to 2 g/ml, the particles flying apart are reduced, resulting in easy operation and less liable to stick to the equipment.

The pH of the nonmagnetic powder is preferably from 2 to 11, and particularly preferably between 6 and 9. When the pH is in the range of 2 and 11, the increase in frictional coefficient under high temperature and high humidity condition or due to migration of a fatty acid can be prevented.

The water content of the nonmagnetic powder is preferably from 0.1 to 5% by weight, more preferably from 0.2 to 3% by weight, and still more preferably from 0.3 to 1.5% by weight. The water content of 0.1 to 5% by weight is preferable because the dispersion is good and the viscosity of the resulting coating composition is stable.

The ignition loss of the nonmagnetic powder is preferably not more than 20% by weight. The powder having small ignition loss is preferable.

When the nonmagnetic powder is inorganic powder, the Mohs hardness thereof is preferably from 4 to 10. When the Mohs hardness is in the range of 4 to 10, the durability is secured. The stearic acid adsorption amount of the nonmagnetic powder if preferably from 1 to 20 μmol/m², and more preferably 2 to 15 μmol/m².

The heat of wetting of the nonmagnetic powder with water at 25° C. is preferably in the range of 20 to 60 μJ/cm² (200 to 600 erg/m²). A solvent in which the nonmagnetic powder releases the heat of wetting in the range described above can be used.

The number of water molecules on the surface of the nonmagnetic powder at 100 to 400° C. is suitably from 1 to 10 per 100 angstroms. The pH of isoelectric point of the nonmagnetic powder in water is preferably between 3 and 9.

It is preferred that the nonmagnetic powder is surface treated to have a surface layer of Al₂O₃, SiO₂, TiO₂, ZrO₂, SnO₂, Sb₂O₃ or ZnO. Among them, Al₂O₃, SiO₂, TiO₂ and ZrO₂ are preferable, and Al₂O₃, SiO₂ and ZrO₂ are more preferable in view of dispersibility. The surface treating substances may be used individually or in combination. According to the purpose, a composite surface layer can be formed by co-precipitation or a method comprising first treating the surface of the nonmagnetic particle with alumina and then treating with silica or vise versa. The surface layer may be porous according to the purpose, but a homogeneous and dense surface layer is ordinarily preferred.

Specific examples of the nonmagnetic powder which can be used in the nonmagnetic layer include Nanotite produced by Showa Denko K.K., HIT-100 and ZA-G1 each produced by Sumitomo Chemical Co., Ltd., DPN-250, DPN-250BX, DPN-245, DPN-270BX, DPB-550BX and DPN-550RX produced by Toda Kogyo Corp., titanium oxide series TTO-51B, TTO-55A, TTO-55B, TTO-55C, TTO-55S, TTO-55D, SN-100 and MJ-7, and α-iron oxide series E270, E271 and E300 each produced by Ishihara Sangyo Kaisha, Ltd., STT-4D, ST-30D, STT-30 and STT-65C each produced by Titan Kogyo K.K., MT-100S, MT-100T, MT-150W, MT-500B, MT-600B, T-100F and T-500HD each produced by Tayca Corp. Further, FINEX-25, BF-1, BF-10, BF-20 and ST-M each produced by Sakai Chemical Industry Co., Ltd., DEFIC-Y and DEFIC-R each produced by Dowa Mining Co., Ltd., AS2BM and TiO2P25 each produced by Nippon Aerosil Co., Ltd., 100A and 500A each produced by Ube Industries, Ltd., and Y-LOP produced by Titan Kogyo K.K. and calcined products thereof are exemplified. itanium dioxide and α-iron oxide are particularly preferable for the nonmagnetic powder.

Carbon black can be incorporated into the nonmagnetic layer to reduce the surface resistivity, to decrease light transmission and to obtain the desired micro Vickers hardness. The micro Vickers hardness of the nonmagnetic layer is preferably from 25 to 60 kg/mm² (0.245 to 0.588 GPa). It is preferably from 30 to 50 kg/mm² (0.294 to 0.490 GPa) for adjusting good head contact. The micro Vickers hardness can be measured with a thin film hardness tester (HMA-400, produced by NEC Corp.) having an indenter equipped with a three-sided pyramid diamond tip having a ridge angle of 80° and a top radius of 0.1 μm. A magnetic recording tape is ordinarily standardized to have the absorption of not more than 3% for infrared ray of around 900 nm. For example, the absorption of VHS tape is standardized to be not more than 0.8%. Carbon black for such purposes includes, for example, furnace black for rubber, thermal black for rubber, carbon black for color and acetylene black.

The specific surface area of the carbon black for use in the nonmagnetic layer is preferably from 100 to 500 m²/g, and more preferably from 150 to 400 m²/g, and the DBP absorption amount thereof is preferably from 20 to 400 ml/100 g, and more preferably from 30 to 200 ml/100 g. The average particle size of the carbon black is from 5 to 80 nm, preferably from 10 to 50 nm, and more preferably from 10 to 40 nm. The pH of the carbon black is preferably from 2 to 10, the water content thereof is preferably from 0.1 to 10% by weight, and the tap density thereof is preferably from 0.1 to 1 g/ml.

Specific examples of the carbon black for use in the nonmagnetic layer according to the invention include BLACKPEARLS 2000, 1300, 1000, 900, 800, 880, and 700 and Vulcan XC-72 each produced by Cabot Corp., #3050B, #3150B, #3250B, #3750B, #3950B, #950, #650B, #970B, #850B and MA-600 each produced by Mitsubishi Chemical Corp. , CONDUCTEX SC and RAVEN 8800, 8000, 7000, 5750, 5250, 3500, 2100, 2000, 1800, 1500, 1255 and 1250 each produced by Columbian Carbon, and Ketjen Black EC produced by Ketjen Black International Co.

Further, carbon black surface treated, for example, with a dispersing agent, resin-grafted carbon black or carbon black with its surface partially graphitized may be used. The carbon black may previously been dispersed in a binder before being added to a coating composition. The carbon black is used in an amount of 50% by weight or less based on the above-described inorganic powder and 40% by weight or less based on the total weight of the nonmagnetic layer. The carbon black may be used individually or in combination. With respect to the carbon black for use in the nonmagnetic layer according to the invention, reference can be made, for example, to Carbon Black Binran (Handbook of Carbon Black), compiled by Carbon Black Kyokai (ed.).

Organic powder may be added to the nonmagnetic layer according to the purpose. Examples of the organic powder include acrylic-styrene resin powder, benzoguanamine resin powder, melamine resin powder and phthalocyanine pigment. Polyolefin resin powder, polyester resin powder, polyamide resin powder, polyimide resin powder and polyfluorinated ethylene resin powder are also used. Methods of preparing the resin powder are described, for example, in JP-A-62-18564 and JP-A-60-255827.

With respect to the binder resin, lubricant, dispersing agent, additive, solvent, method of dispersion and the like, those described for the magnetic layer can be applied. In particular, known techniques as for the magnetic layer are useful with respect to the amount and kind of binder resin, the additive, and the amount and kind of dispersing agent.

### 4. Backcoat Layer

In general, a magnetic tape for a computer data recording is strongly required to have an excellent repeating-running property in comparison with a video tape and an audio tape. In order to maintain such a high preservation stability, a backcoat layer can also be provided on the surface of the nonmagnetic support opposite to the surface provided the nonmagnetic layer and the magnetic layer. A coating solution for forming the backcoat layer comprises a particle component, for example, an abrasive or an antistatic agent and a binder dispersed in an organic solvent. As the particle component, various kinds of inorganic pigments and carbon black can be used. As the binder, a resin, for example, nitrocellulose, a phenoxy resin, a vinyl chloride resin or a polyurethane resin can be used individually or in combination.

### 5. Layer Construction

In the construction of the magnetic recording material for use in the invention, the thickness of the nonmagnetic support is preferably from 3 to 80 pm.

The thickness of the smoothing layer is preferably from 0.05 to 1.5 μm, more preferably from 0.1 to 1.0 μm, and further more preferably from 0.2 to 0.8 μm. The thickness of the backcoat layer provided on the surface of the nonmagnetic support opposite to the surface provided the nonmagnetic layer and the magnetic layer preferably from 0.1 to 1.0 μm, and more preferably from 0.2 to 0.8 μm.

The thickness of the magnetic layer is optimized according to the saturation magnetization amount of a magnetic head to be used, the head gap length and the recording signal zone, and it is preferably 0.15 μm or less, for example, from 0.01 to 0.10 μm, more preferably from 0.02 to 0.08 μm, and still more preferably from 0.03 to 0.08 μm. A fluctuation rate of the thickness of the magnetic layer is preferably ±50% or less, and more preferably ±40% or less. The magnetic layer is present at least one and it may be divided into two or more layers having different magnetic characteristics from each other. The construction of known multilayer magnetic layer can be applied to the invention.

The thickness of the nonmagnetic layer is preferably from 0.2 to 3.0 μm, more preferably from 0.3 to 2.5 μm, and still more preferably from 0.4 to 2.0 μm. The nonmagnetic layer of the magnetic recording medium according to the invention exhibits the effect thereof as long as it is substantially nonmagnetic. For instance, even when the nonmagnetic layer contains as an impurity, or intentionally, a small amount of magnetic material, it can be considered that such a magnetic recording medium has substantially same construction as the magnetic recording medium according to the invention as long as the nonmagnetic layer exhibits the effect of the invention. The term “substantially same” as used herein mans that the residual magnetic flux density of the nonmagnetic layer is 10 mT (100G) or less or the coercive force of the nonmagnetic layer is 7.96 kA/m (100 Oe) or less, preferably the residual magnetic flux density and the coercive force are zero.

### 6. Production Method

A method of preparing a coating solution for forming the magnetic layer of the magnetic recording material for use in the magnetic recording medium according to the invention comprise at least a kneading step, a dispersing step and, if desired, mixing steps to be carried out before and/or after the kneading and dispersing steps. Each of the steps may be composed of two or more separate stages. The materials, for example, the magnetic powder, the nonmagnetic powder, the inorganic powder, the binder, the carbon black, the antistatic agent, the lubricant and the solvent for use in the invention may be added in any step at any time, and each material may be added in two or more separate steps. For example, polyurethane may be added in parts in the kneading step, the dispersing step, or the mixing step for adjusting viscosity after dispersion. For achieving the object of the invention, a conventionally known producing technique can be partly used. It is preferred to use a machine having strong kneading power, for example, an open kneader, a continuous kneader, a pressure kneader or an extruder in the kneading step. Details of the kneading treatment are described in JP-A-1-106338 and JP-A-1-79274. When the coating solution for magnetic layer and the coating solution for nonmagnetic layer are dispersed, glass beads can be used. As the glass beads, dispersing media having a high specific gravity, for example, zirconia beads, titania beads and steel beads are preferably used. The particle size and filling rate of the dispersing media are optimized to use. As the dispersing machine, known dispersing machine can be used.

The method for production of a magnetic recording medium according to the invention comprises, for example, coating on the surface of a moving nonmagnetic support a coating solution for forming a smoothing layer, followed by drying and undergoing irradiation with radiation to form a smoothing layer, coating on the smoothing layer a coating solution for forming a nonmagnetic layer containing nonmagnetic powder and a binder, followed by drying to form a nonmagnetic layer, and coating on the nonmagnetic layer a coating solution for forming a magnetic layer containing ferromagnetic powder, inorganic powder and a binder, followed by drying to form a magnetic layer. The coating solution for forming a magnetic layer may be coated by a multilayer coating method. Specifically, the coating solution formagnetic layer to form the lower layer and the coating solution for magnetic layer to form the upper layer may be multi-coated successively or simultaneously. A coating equipment for coating the coating solution includes, for example, an air doctor coater, a blade coater, a rod coater, an extrusion coater, an air knife coater, a squeegee coater, an impregnation coater, a reverse roll coater, a transfer roll coater, a gravure coater, a kiss coater, a cast coater, a spray coater and a spin coater. For details of the coating techniques, reference can be made, for example, to Saishin Coating Gijutsu (Newest Coating Techniques), published by Sogo Gijutsu Center Co., Ltd. (May 31, 1983).

With respect to the coating layer of the coating solution for forming the magnetic layer, in the case of a magnetic tape, the ferromagnetic powder contained in the coating layer formed from the coating solution for magnetic layer is oriented in the longitudinal direction using a cobalt magnet or a solenoid. In the case of a disk, although sufficiently isotropic orientation can sometimes be obtained without orientation using an orientation apparatus, it is preferred to use a known random orientation apparatus in which cobalt magnets are obliquely arranged in an alternate manner or an alternating magnetic field is applied with a solenoid. In using the ferromagnetic metal powder, the “isotropic orientation” is ordinarily preferably in-plane, two-dimensional random orientation but may be in-plane and perpendicular, three-dimensional random orientation. While the hexagonal ferrite is liable to have in-plane and perpendicular, three-dimensional random orientation but can have in-plane two-dimensional random orientation. It is also possible to provide a disk with circumferentially isotropic magnetic characteristics by perpendicular orientation in a known manner, for example, by using facing magnets with their polarities opposite. The perpendicular orientation is particularly preferred for high density recording. The circumferential orientation may be achieved by spin coating.

It is preferred that the temperature and amount of drying air and the coating speed are adjusted to control the drying position of the coating layer. The coating speed is preferably from 20 to 1,000 m/min, and the temperature of the drying air is preferably 60° C. or higher. The coating layer may be appropriately pre-dried before entering the magnet zone.

After drying, the coating layer is ordinarily subjected to a surface smoothing treatment or a thermo treatment. For the surface smoothing treatment, for example, a super calender roll is employed. By performing the surface smoothing treatment, voids formed by elimination of the solvent at the drying disappear and a filling rate of the ferromagnetic powder in the magnetic layer increases so that the magnetic recording material excellent in the electromagnetic conversion characteristics can be obtained.

As the calender treatment roll, a roll made of heat resistant plastic, for example, an epoxy resin, polyimide, polyamide or polyamideimide is used. A metal roll may also be employed to the calender treatment.

With respect to the conditions of the calender treatment, it is performed at a calender roll temperature ranging from 60 to 100° C., preferably from 70 to 100° C., and particularly preferably from 80 to 100° C., under a pressure ranging from 100 to 500 kg/cm (98 to 490 kN/m), preferably from 200 to 450 kg/cm (196 to 441 kN/m), and particularly preferably 300 to 400 kg/cm (294 to 392 kN/m).

As a means for reducing the thermal shrinkage rate, a method for heat treatment of the magnetic recording material in the form of web while handling with low tension and a method for heat treatment (thermo treatment) of the magnetic recording material in the form of stack, for example, as a bulk or in the form stored in a cassette are known, and both methods can be utilized. The former method is less influenced with transfer of protrusion on the surface of backcoat layer but can not remarkably reduce the thermal shrinkage rate. On the contrary, although the latter thermo treatment can greatly improved the thermal shrinkage rate, since it is strongly influenced with transfer of protrusion on the surface of backcoat layer, the surface of magnetic layer is roughened to cause the decrease of output and the increase of noise. According to the invention, the magnetic recording material of high output and low noise can be supplied, even when it is subjected to the thermo treatment. The magnetic recording material thus-obtained is cut into the desired size for use by a cutting machine or a clicking machine.

In the magnetic recording medium according to the invention, the fluctuation rate of the interface between the magnetic layer and the nonmagnetic layer is preferably 20% or less. By controlling the fluctuation rate of the interface between the magnetic layer and the nonmagnetic layer to 20% or less, the fluctuation of output is restrained and the error rate can be decreased.

The fluctuation rate is ideally zero, because as it is small, the fluctuation of output is low.

The fluctuation rate at the interface can be determined by embedding the magnetic recording medium in an epoxy resin, followed by curing, cutting the embedded magnetic recording medium by a diamond cutter in the longitudinal direction of the magnetic recording medium to prepare a section having a thickness of about 800 angstroms, observing the cross-section of the section by TEM at 100,000-fold magnification, tracing the interface of the cross-sectional photograph 10 μm in length, obtaining the average thickness d of the magnetic layer and standard deviation a by an image analyzer, and calculating according to a formula: 100×σ/d (%)

### 7. Physical Properties

The saturation magnetic flux density of the magnetic layer of the magnetic recording medium according to the invention is preferably from 100 to 400 mT (1,000 to 4,000 G). The coercive force (Hc) of the magnetic layer is preferably from 143.3 to 318.4 kA/m (1,800 to 4,000 Oe), and more preferably from 159.2 to 278.6 kA/m 2,000 to 3,500 Oe). The coercive force distribution is preferably narrow, and SFD and SFDr are preferably 0.6 or less, and more preferably 0.4 or less, respectively.

The friction coefficient against head of the magnetic recording medium according to the invention in the range of temperature of −10° C. to 40° C. and humidity of 0% to 95% is preferably 0.5 or less, and more preferably 0.3 or less. The charge potential thereof is preferably in the range of −500 V to +500 V. The elastic modulus at 0.5% elongation of the magnetic layer is preferably from 0.98 to 19.6 GPa (100 to 2,000 kg/mm²) in every direction of in-plane, and the breaking strength thereof is preferably from 98 to 686 MPa (10 to 70 kg/cm²). The elastic modulus of the magnetic recording medium is preferably from 0.98 to 14.7 GPa (100 to 1,500 kg/mm²) in every direction of in-plane, the residual elongation thereof is preferably 0.5% or less, and the thermal shrinkage factor thereof at every temperature of 100° C. or less is preferably 1% or less, more preferably 0.5% or less, and most preferably 0.1% or less.

The glass transition temperature of the magnetic layer (the maximum of loss elastic modulus on dynamic viscoelasticity measurement at 110 Hz) is preferably from 50° C. to 180° C., and that of the nonmagnetic layer is preferably from 0° C. to 180° C. The loss elastic modulus of the magnetic layer is preferably in the range of 1×10⁷ to 8×10⁸ Pa (1×10⁸ to 8×10⁹ dyne/cm2), and the loss tangent thereof is preferably 0.2 or less. When the loss tangent is too large, the adhesion failure is liable to occur. These thermal and mechanical characteristics are preferably almost equal in every direction of in-plane of the magnetic recording medium within difference of 10% or less.

The residual amount of solvent in the magnetic layer is preferably 100 mg/m² or less, and more preferably 10 mg/m² or less. The void ratio of the coating layer is preferably 30% by volume or less, and more preferably 20% by volume or less, with both of the nonmagnetic layer and the magnetic layer. The void ratio is preferably smaller for obtaining the high output but the specific value should be preferably secured depending on purposes in some cases. For instance, in a disc medium with which the repeated use is emphasized, a large void ratio is preferable for the preservation stability in many cases.

The magnetic layer according to the invention preferably has the maximum height (SRmax) of 0.5 μm or less, the ten point average roughness (SRz) of 0.3 μm or less, the central plane peak height (SRp) of 0.3 μm or less, the central plane valley depth (SRv) of 0.3 μm or less, the central plane area factor (SSr) of from 20% to 80%, and the average wavelength (Sλa) of 5 to 300 μm. The surface protrusions of the magnetic layer having a size of 0.01 to 1 μm can be appropriately set in the range of a number of 0 to 2,000, and it is preferred to optimize the electromagnetic conversion characteristics and friction coefficient by setting the surface protrusion. These characteristics can be easily controlled by controlling the surface property of the magnetic layer by filler in the support, the particle size and the amount of the magnetic powder added to the magnetic layer, or the surface configuration of the roller used in calendering treatment. The curling is preferably adjusted within the range of ±3 mm.

It is easily presumed that between the nonmagnetic layer and the magnetic layer of the magnetic recording medium according to the invention, these physical properties can be varied depending on the purpose in the nonmagnetic layer and the magnetic layer. For instance, the elastic modulus of the magnetic layer is increased to improve the preservation stability and at the same time the elastic modulus of the nonmagnetic layer is made lower than that of the magnetic layer, thereby improving the head touching of the magnetic recording medium.

Although the magnetic recording medium according to the invention is not particularly restricted with respect to the head for reproducing the signal magnetically recorded on the magnetic recording medium, it is preferably used for an MR head. In the case of using the MR head for the reproduction of the magnetic recording medium according to the invention, the MR head is not particularly restricted and for example, a GMR head a TMR head can be used. The head using for the magnetic recording is also not particularly restricted and the saturation magnetization of the head is 1.0 T or more, and preferably 1.5 T or more.

### EXAMPLES

The present invention will be described in more detail below with reference to the examples, but the invention should not be construed as being limited thereto. In the examples, the term “part” means “part by weight” unless otherwise indicated.

### Example 1

<Magnetic Layer>

| | | |
|---|---|---|
| Ferromagnetic metal powder (composition: Fe/Co = 100/ | 100 | parts |
| 30; Hc: 2,500 Oe (200 kA/m); specific surface | | |
| area by BET method: 69 m²/g; surface treatment layer: | | |
| Al₂O₃, SiO₂, Y₂O₃; particle size (average major axis | | |
| length): 35 nm; acicular ratio: 6; σs: 100 emu/g | | |
| (100 A · m²/kg); water-soluble Na amount: 20 ppm; | | |
| water-soluble Ca amount: 10 ppm; water-soluble Fe | | |
| amount: 1 ppm;) | | |
| Vinyl chloride copolymer (MR 100, produced by Zeon | 12 | parts |
| Corp.) | | |
| Polyurethane resin (Tg: 80° C.) | 5 | parts |
| α-Al₂O₃ (Mohs hardness: 9; average particle size: | 10 | parts |
| 0.15 μm) | | |
| Carbon black (average particle size: 0.08 μm) | 0.5 | parts |
| Butyl stearate | 1 | part |
| Stearic acid | 5 | parts |
| Methyl ethyl ketone | 90 | parts |
| Cyclohexanone | 30 | parts |
| Toluene | 60 | parts |

The above components of the coating composition were kneaded in an open kneader and dispersed in a sand mill. To the dispersion was added 40 parts of a mixed solvent of methyl ethyl ketone and cyclohexanone. The dispersion was filtered through a filter having an average pore diameter of 1 μm to prepare a coating solution for forming a magnetic layer.

<Nonmagnetic Layer>

| | | |
|---|---|---|
| Nonmagnetic powder: α-Fe₂O₃ hematite (average major | 80 | parts |
| axis length: 0.10 μm; specific surface area by BET | | |
| method: 52 m²/g; pH: 6; tap density: 0.8 g/ml; DPB | | |
| absorption amount: 27 to 38 ml/100 g; surface | | |
| treatment layer: Al₂O₃, SiO₂; water-soluble Na | | |
| amount: 30 ppm; water-soluble Ca amount: 5 ppm; | | |
| water-soluble Fe amount: 1 ppm;) | | |
| Carbon black (average primary particle size: 16 nm; | 20 | parts |
| DBP absorption amount: 80 ml/100 g; pH: 8.0; specific | | |
| surface area by BET method: 250 m²/g; volatile | | |
| content: 1.5%) | | |
| Vinyl chloride copolymer (MR 100, produced by Zeon | 17 | parts |
| Corp.) | | |
| Polurethane resin (UR 8200, produced by Toyobo Co., | 5 | parts |
| Ltd.) | | |
| α-Al₂O₃ (average particle size: 0.2 μm) | 5 | parts |
| Butyl stearate | 1 | part |
| Stearic acid | 1 | part |
| Methyl ethyl ketone | 100 | parts |
| Cyclohexanone | 50 | parts |
| Toluene | 50 | parts |

The above components of the coating composition were kneaded in an open kneader and dispersed in a sand mill. To the dispersion was added 40 parts of a mixed solvent of methyl ethyl ketone and cyclohexanone. The dispersion was filtered through a filter having an average pore diameter of 1 μm to prepare a coating solution for forming a nonmagnetic layer.

### <Smoothing Layer>

The components shown in Table 1 below were mixed to prepare Coating Solution P1 to P4 for forming a smoothing layer, respectively.

TABLE 1

| | | | B-Type | Curing |
|---|---|---|---|---|
| | | | Viscosity | Means of |
| | Material | | [mPa · sec] | Coating |
| P1 | DCP-A (produced by | 15 parts | 2.0 | Curing |
| | Kyoeisha Chemical Co., Ltd.) | | | with |
| | Methyl ethyl ketone | 100 parts | | electron |
| | | | | beam |
| | | | | after |
| | | | | drying |
| P2 | R604 (produced by Nippon | 40 parts | 2.0 | Curing |
| | Kayaku Co., Ltd.) | | | with |
| | Methyl ethyl ketone | 60 parts | | electron |
| | | | | beam |
| | | | | after |
| | | | | drying |
| P3 | Water-soluble Nylon A-90 | 20 parts | 106 | Drying |
| | (produced by Toray | | | |
| | Industries, Inc.) | | | |
| | Methanol | 80 parts | | |
| P4 | Polyurethane Resin UR8200 | 10 parts | 220 | Drying |
| | (produced by Toyobo Co., | | | |
| | Ltd.) | | | |
| | Methyl ethyl ketone | 90 parts | | |

<Backcoat Layer>

| | | |
|---|---|---|
| Carbon black A (average particle size: 40 nm) | 100 | parts |
| Carbon black B (specific surface area by BET method: | 100 | parts |
| 115 m²/g; average particle size: 90 nm; DPB | | |
| absorption amount: 70 ml/100 g) | | |
| Nitrocellulose RS1/2 | 90 | parts |
| Polyurethane resin (UR8200, produced by Toyobo Co., | 50 | parts |
| Ltd.) | | |
| Dispersing agent: | | |
| Phthalocyanine dispersing agent | 5 | parts |
| Copper oleate | 5 | parts |
| Barium sulfate (precipitate) | 5 | parts |
| Methyl ethyl ketone | 800 | parts |
| Toluene | 800 | parts |

The above components were previously kneaded in a roll mill and then dispersed in a sand grinder. To the dispersion were added 5 parts by weight of Polyester resin (Vylon 300, produced by Toyobo Co., Ltd.) and 5 parts of polyisocyanate (Coronate L, produced by Nippon Polyurethane Industry Co., Ltd.) to prepare a coating solution for backcoat layer.

Coating Solution P1 for forming a smoothing layer was coated on a support (material: PEN; Young's modulus: 9 GPa) so as to have a thickness after drying of 0.4 μm, dried and cured with EB irradiation of 30 kGry to prepare a smoothing layer (Young's modulus: 4 GPa). The coating solution for forming a nonmagnetic layer was coated on the smoothing layer so as to have a thickness after drying of 0.6 μm and dried to prepare a nonmagnetic layer. The coating solution for forming a magnetic layer was coated on the nonmagnetic layer so as to have a thickness after drying of 0.1 μm and dried to prepare a magnetic layer. The coating solution for backcoat layer was coated on the surface of the support opposite to the magnetic layer to prepare a backcoat layer having a thickness of 0.4 μm. The resulting magnetic recording medium was treated with 7-roll calender composed of metal rolls at temperature of 100° C. and running speed of 200 m/min and then slit to ½ inch in width to prepare a magnetic recording tape for data recording, which was used as a sample of Example 1.

### Example 2

A magnetic recording tape for data recording was prepared in the same manner as in Example 1 except for changing Coating Solution P1 for forming a smoothing layer to Coating Solution P2 for forming a smoothing layer.

### Example 3

A magnetic recording tape for data recording was prepared in the same manner as in Example 1 except for changing the thickness of the magnetic layer to 0.15 μm.

### Example 4

A magnetic recording tape for data recording was prepared in the same manner as in Example 2 except for changing the thickness of the magnetic layer to 0.05 μm.

### Example 5

A magnetic recording tape for data recording was prepared in the same manner as in Example 1 except for changing Coating Solution P1 for forming a smoothing layer to Coating Solution P3 for forming a smoothing layer. The temperature for drying was adjusted at 90° C.

### Example 6

A magnetic recording tape for data recording was prepared in the same manner as in Example 1 except for changing Coating Solution P1 for forming a smoothing layer to Coating Solution P4 for forming a smoothing layer. The temperature for drying was adjusted at 90° C.

### Comparative Example 1

A magnetic recording tape for data recording was prepared in the same manner as in Example 1 except that the smoothing layer was not formed and the thickness of the nonmagnetic layer was changed to 1.0 μm.

### Comparative Example 2

A magnetic recording tape for data recording was prepared in the same manner as in Comparative Example 1 except the nonmagnetic layer and the magnetic layer were formed by a simultaneous multilayer coating (wet-on-wet) system.

### Comparative Example 3

A magnetic recording tape for data recording was prepared in the same manner as in Comparative Example 2 except for changing the amount of α-alumina added to the magnetic layer to 2 parts.

### Comparative Example 4

A magnetic recording tape for data recording was prepared in the same manner as in Comparative Example 1 except for changing the amount of α-alumina added to the magnetic layer to 2 parts.

### Comparative Example 5

A magnetic recording tape for data recording was prepared in the same manner as in Comparative Example 1 except for changing the thickness of the magnetic layer to 0.2 μm.

### Comparative Example 6

A magnetic recording tape for data recording was prepared in the same manner as in Comparative Example 1 except for changing the abrasive added to the magnetic layer to α-alumina having an average particle size of 0.05 μm.

With the magnetic recording tape for data recording prepared in each of the examples and comparative examples, centerline average surface roughness Ra on the surface of the magnetic layer, a number of abrasive protruded through the surface of the magnetic layer, an SN ratio, durability and abrasion of head were determined. The methods for measurement and evaluation results are described below.

### Centerline Average Surface Roughness Ra on the Surface of the Magnetic Layer:

The surface roughness was measured in 40 μm square using NanoScope 3 (AFM, atomic force microscope) produced by Digital Instruments, Inc. with a pyramid SiN probe having a ridge angle of 70°.

### Number of Abrasive Protruded Through the Surface of the Magnetic Layer:

The number of the abrasive on the surface of the recording tape was counted by observing five electron micrograms at 20,000-fold magnification.

### SN Ratio:

The SN ratio was measured by the method described in Annex B of Standard ECMA-319.

### Durability:

Using a drive of Standard LTO1, the recording tape was run reciprocally 100 times with all data length of cartridge under an environment of temperature of 23° C. and humidity of 50% RH, then staining of the reproducing head was observed and the case wherein the stain accumulated on the whole surface of the head was deemed lack of durability (indicated as X).

### Abrasion of Head:

The abrasion of head was measured by the method described in Annex C of Standard ECMA-319 and the case wherein the standard was not fulfilled was determined that the abrasion of head was poor (indicated as X).

The results obtained are shown in Table 2 below.

TABLE 2

| | Smoothing | | Nonmagnetic | Magnetic | | | Number of | SN | | Abrasion |
|---|---|---|---|---|---|---|---|---|---|---|
| | layer | | Layer | layer | | Ra | Abrasive | Ratio | | of Head |
| | (μm) | | (μm) | (μm) | Coating Method | (nm) | (/100 μm²) | (dB) | Durability | (μm) |
| Example 1 | P1 | 0.4 | 0.6 | 0.1 | Successively | 1.9 | 125 | +2.8 | ◯ | ◯ |
| | | | | | | | | | (good) | (good) |
| Example 2 | P2 | 0.4 | 0.6 | 0.1 | Successively | 1.6 | 130 | +3.6 | ◯ | ◯ |
| Example 3 | P2 | 0.4 | 0.6 | 0.15 | Successively | 2.0 | 121 | +2.7 | ◯ | ◯ |
| Example 4 | P2 | 0.4 | 0.6 | 0.05 | Successively | 1.5 | 140 | +3.7 | ◯ | ◯ |
| Example 5 | P3 | 0.4 | 0.6 | 0.1 | Successively | 2.3 | 128 | +1.4 | ◯ | ◯ |
| Example 6 | P4 | 0.4 | 0.6 | 0.1 | Successively | 2.4 | 131 | +1.1 | ◯ | ◯ |
| Comparative | — | — | 1.0 | 0.1 | Successively | 3.0 | 133 | 0 | ◯ | X |
| Example 1 | | | | | | | | | | |
| Comparative | — | — | 1.0 | 0.1 | Simultaneously | 3.9 | 126 | −2.0 | ◯ | ◯ |
| Example 2 | | | | | | | | | | |
| Comparative | — | — | 1.0 | 0.1 | Simultaneously | 3.2 | 42 | −0.3 | X | ◯ |
| Example 3 | | | | | | | | | | |
| Comparative | — | — | 1.0 | 0.1 | Successively | 2.8 | 40 | +0.5 | X | ◯ |
| Example 4 | | | | | | | | | | |
| Comparative | — | — | 1.0 | 0.2 | Successively | 3.5 | 131 | −1.0 | ◯ | ◯ |
| Example 5 | | | | | | | | | | |
| Comparative | — | — | 1.0 | 0.1 | Successively | 3.0 | 250 | 0 | X | ◯ |
| Example 6 | | | | | | | | | | |

In Examples 1 to 6, in which the nonmagnetic layer and magnetic layer are provided on the smoothing layer by the successive coating method defined according to the invention, the decrease in Ra resulting in the high SN ratio and securing of the number of abrasive satisfying both the durability and the abrasion property can be achieved. On the contrary, in Comparative Example 1, since the smoothing layer is not present, the cushioning effect does not arise and the abrasive is not sufficiently embedded, resulting in the increase of the abrasion of head, although the decrease in Ra is achieved to some extent by the successive coating method. In Comparative Example 2, the surface property for obtaining the sufficient SN ratio is not obtained, although the satisfaction both of the durability and the abrasion property can be achieved by employing the simultaneous coating method. In Comparative Examples 3 and 4, the durability is severely poor, although the improvements in the abrasion of head and SN ratio are possible by decreasing the amount of the abrasive in the magnetic layer. In Comparative Example 5, the surface property degrades and the sufficient SN ratio is not obtained, although the increase of the abrasion of head due to the protrusion of the abrasive is prevented by increasing the thickness of the magnetic layer. In Comparative Example 6, the sufficient abrasion property is not obtained and the durability is severely poor, although the abrasion of head due to the protrusion of the abrasive is prevented by using the abrasive having small particle size in comparison with that in Comparative Example 1.

This application is based on Japanese Patent application JP 2006-86360, filed Mar. 27, 2006, the entire content of which is hereby incorporated by reference, the same as if set forth at length.

What is claimed is:

1. A magnetic recording medium comprising:
a nonmagnetic support;
a smoothing layer containing a polymer;
a nonmagnetic layer formed by coating a first solution containing nonmagnetic powder and a binder on the smoothing layer and drying the coated first solution; and
a magnetic layer formed by coating a second solution containing ferromagnetic powder, inorganic powder and a binder on the nonmagnetic layer and drying the coated second solution, in this order.

2. The magnetic recording medium as claimed in claim 1, wherein an average particle size of the inorganic powder contained in the magnetic layer is no less than a thickness of the magnetic layer.

3. The magnetic recording medium as claimed in claim 1, wherein the magnetic layer has a thickness of not more than 0.15 μm.

4. The magnetic recording medium as claimed in claim 2, wherein the magnetic layer has a thickness of not more than 0.15 μm.

5. The magnetic recording medium as claimed in claim 1, wherein the magnetic layer has a thickness of from 0.01 to 0.10 μm.

6. The magnetic recording medium as claimed in claim 2, wherein the magnetic layer has a thickness of from 0.01 to 0.10 μm.

7. The magnetic recording medium as claimed in claim 1, wherein the smoothing layer has a Young's modulus of from 10 to 90% of a Young's modulus of the nonmagnetic support.

8. The magnetic recording medium as claimed in claim 2, wherein the smoothing layer has a Young's modulus of from 10 to 90% of a Young's modulus of the nonmagnetic support.

9. The magnetic recording medium as claimed in claim 1, wherein the smoothing layer has a Young's modulus of from 1 to 8 Gpa.

10. The magnetic recording medium as claimed in claim 2, wherein the smoothing layer has a Young's modulus of from 1 to 8 Gpa.

11. The magnetic recording medium as claimed in claim 1, wherein a number of the inorganic powder protruded through a surface of the magnetic layer is from 50 to 200/100 μm².

12. The magnetic recording medium as claimed in claim 2, wherein a number of the inorganic powder protruded through a surface of the magnetic layer is from 50 to 200/100 μm².

13. The magnetic recording medium as claimed in claim 1, wherein the magnetic layer has a centerline average surface roughness of from 1.5 to 3.0 nm.

14. The magnetic recording medium as claimed in claim 2, wherein the magnetic layer has a centerline average surface roughness of from 1.5 to 3.0 nm.

15. The magnetic recording medium as claimed in claim 1, wherein the smoothing layer has a thickness of from 0.05 to 1.5 μm.

16. The magnetic recording medium as claimed in claim 2, wherein the smoothing layer has a thickness of from 0.05 to 1.5 μm.

17. The magnetic recording medium as claimed in claim 1, wherein the nonmagnetic support has a thickness of from 3 to 80 μm.

18. The magnetic recording medium as claimed in claim 2, wherein the nonmagnetic support has a thickness of from 3 to 80 μm.

19. A method for producing a magnetic recording medium, comprising:
coating a first solution on a nonmagnetic support and drying the coated first solution to form a smoothing layer containing a polymer;
coating a second solution containing nonmagnetic powder and a binder on the smoothing layer and drying the coated second solution to form a nonmagnetic layer; and
coating a third solution containing ferromagnetic powder, inorganic powder and a binder on the nonmagnetic layer and drying the coated third solution to form a magnetic layer,
in this order.
